(19) United States
(12) Patent Application Publication
(10) Pub. No.: US 2002/0038280 A1
(43) Pub. Date: Mar. 28, 2002

(54) Online property exchange

(76) Inventor: Daniel A. Levy, New York, NY (US)

Correspondence Address: Clifford Chance Rogers & Wells LLP, 200 Park Avenue, New York, NY, 10166-0153, US

(21) Appl. No.: 09/938,900

(22) Filed: Aug. 24, 2001

Related U.S. Application Data
(60) Provisional application No. 60/227,923, filed on Aug. 25, 2000.

(51) Int. Cl. G06F 17/60

(52) U.S. Cl. 705/37; 705/1

(57) ABSTRACT

This invention provides a computer-implemented method and system for facilitating property transactions. This method and system includes profiling geographic areas and profiling a property seeker. The property seeker supplies seeker data including property characteristics desired by the property seeker, neighborhood features desired by the property seeker, and financial data describing the property seeker. The geographic areas are matched with the seeker data. The matched geographic areas and seeker data are presented. The method and system also provides for facilitating a property seeker's decision to market the property. The method and system can also provides for facilitating the exchange of information between the property supplier and the property seeker.

### CROSS-REFERENCE TO RELATED APPLICATION

This application claims the benefit of the filing date of U.S. provisional application serial No. 60/227,923 entitled “Online Property Exchange,” which was filed on Aug. 25, 2000.

### BACKGROUND

Real estate transactions involve bringing together the right buyers, renters, and sellers. This process can be arduous at times because it can be difficult to match the property characteristics that the buyer or renter desires with the available properties that the seller provide.

Typically, the matching of buyer or renter with seller is done through an agent contact. Using an agent contact, a seller contacts the agent who then lists the property in its database. Sellers or brokers affiliated with the agent can access information about this property when they have an interested buyer. While this system can result in the renting or selling of the property, it can be inefficient. In locations with many properties for sale or rent, it can be difficult to narrow down which property is right for which buyer or renter.

Many computer-based products are available to aid buyers and sellers in the real estate market. None of these products, however, addresses all of the needs of a property owner who is considering selling a property, or a property broker who is representing such an owner. For example, it is sometimes difficult for a property owner to price a property because the current sales of the area are unknown. The property owner also cannot always find interested buyers or renters that fit the financial needs of the property. Scheduling appointments and communications between buyers, renters, and sellers can also be difficult. Effective communications between these parties can be important to closing a successful deal.

What is needed, therefore, is a system that fulfills these needs through a single source.

### SUMMARY

In one aspect, the invention provides a computer implemented method of facilitating real estate transactions. This method includes profiling a plurality of geographic areas and a property seeker. The property seeker supplies seeker data including property characteristics desired by the property seeker, neighborhood features desired by the property seeker, and financial data describing the property seeker. The plurality of geographic areas are then matched with the seeker data and the matched geographic areas and seeker data are presented. The method also provides for facilitating a property supplier's decision to market the property.

This invention can provide for profiling the property, where the property is controlled by a property supplier, and the property supplier supplies property data including characteristics of the property, neighborhood features, and financial data describing the property. The property seeker can be matched with the property using the seeker data and the property data. The matched property and property seeker can be presented. The method also provides for facilitating the exchange of information between the property supplier and the property seeker.

Each property can be profiled by individuals supplying information regarding the property, including reviews and ratings. The profiled properties can be presented to an interested property seeker. The individual can include a person who is a current tenant of the property or a property seeker who has visited the property.

The property characteristics can include available moving-in times, number of bedrooms, number of bathrooms, housing type, and neighborhood. The property characteristics can also include the number of occupants, the doorman availability, whether pets are allowed, and the type of apartment furnishings. A choice of desired amenities can also be included, such as whether the property is a comer unit, penthouse, on the ground floor, has a balcony, central air-conditioning, dining room, den, eat-in kitchen, dressing room, elevator, garage, good light, hardwood floors, health club, living room, fireplace, Jacuzzi, high ceilings, home office, library, foyer, maid's room, pantry, windowed kitchen, duplex, triplex, post-war building, pre-war building, views, exposures, walk-up, and has a washer and dryer in apartment or a washer and dryer in building.

The neighborhood features can include a choice of desired features, including neighborhood demographics, churches, schools, parks, zoos, sport arenas, sport facilities, gyms, museums, theatres, mass transit, restaurants, shopping, art galleries, fashion galleries, and childcare facilities.

The property seeker can include an entity buying property or an entity renting property. The property supplier can include an entity selling property, an entity offering property for rent, or an entity brokering property.

Statistics can be compiled for the exchanged properties. These statistics can include information about an exchanged property's financial information, information about an exchanged property's neighborhood, and information about an exchanged property's property type.

The types of information that can be exchanged can include the scheduling of appointments between the property supplier and the property seeker and the exchanging of messages between the property supplier and the property seeker. The messages can be anonymous messages. The information exchanged can include offers and counteroffers by the property seeker and the property supplier for the property.

The profiling of the properties can include supplying pictures of the property with the property profile. The financial data can include a transaction type the property seeker plans to use.

In another aspect of this invention, a computer system for providing property exchange is provided. The computer system includes a computer server accessible via a computer communications network. The server includes a memory and a processor. Executable software resides in the server memory and is operative with the processor to profile a plurality of geographic areas. The software is also operative to profile a property seeker, where the property seeker supplies seeker data including, property characteristics desired by the property seeker, neighborhood features desired by the property seeker, and financial data describing the property seeker. The software is also operative to match the plurality of geographic areas with the seeker data and present the matched geographic areas and seeker data. Finally, the software is operative to facilitate a property seeker's decision to market a property.

The software can be executable on demand via a network access device. The network access device can include a computer. The computer communication network can conform to a transmission control protocol/Internet protocol. The computer communication network can include an intranet. The computer system of can include a web interface for accessing the executable software stored on the server storage medium.

In another aspect of this invention, a computer data signal for providing property exchange embodied in a digital data stream is presented. The computer data signal is generated by a method that includes profiling geographic areas. The property seeker is also profiled and the property seeker supplies seeker data that includes property characteristics desired by the property seeker, neighborhood features desired by the property seeker, and financial data describing the property seeker. The geographic areas are then matched with the seeker data. The matched geographic areas and seeker data are presented. The property seeker's decision to market a property is then facilitated. The computer data signal generated can adhere to the transmission control protocol/Internet protocol.

In another aspect of this invention, a graphical user interface is presented. The interface includes a web page displayable on an internet compatible browser. The web page includes links to profile a plurality of geographic areas. Links are also provided to profile a property seeker, where the property seeker supplies seeker data that includes property characteristics desired by the property seeker, neighborhood features desired by the property seeker, and financial data describing the property seeker. Links are also provided to match the plurality of geographic areas with the seeker data and present the matched geographic areas and seeker data. The web page also includes links to facilitate a property seeker's decision to market a property.

The web page can additionally include links to electronic messages between a property seeker and a property suppliers, current portfolios, and search listings. The listings can include buyer information, renter information, broker information, and most popular listings.

The messages can include scheduled meetings between the property seekers and the property suppliers, offers, counteroffers, and applications from the property seekers to the property suppliers, and open house information. The most popular listings can include most popular neighborhoods, most popular brokers, and most popular properties.

The details of one or more embodiments of the invention are set forth in the accompanying drawings and the description below. Implementations can provide the following advantages: Communications between buyers, renters, sellers, and brokers can be facilitated electronically, so that parties can send messages to one another and schedule common appointments. Similarly, open houses can be electronically scheduled for interested buyers and renters, with the property supplier knowing approximately how many interested buyers and renters may attend. Statistics of current trends in neighborhood property values can be stored and displayed to keep property suppliers and seekers informed of current values. All property exchange services can be accessed from one electronic location.

### DESCRIPTION OF THE DRAWINGS

FIG. 1 describes the method for exchanging property.

FIG. 2 is an example of a web page for a property supplier to enter property information.

FIG. 3 is an example of a web page for a property seeker to enter property information.

FIG. 4 is an example of an interface for property seekers and property suppliers to exchange information.

FIG. 5 is an example of a web page for a property seeker to search for property suppliers.

FIG. 6 is an example of a web page for a property supplier to seek for buyers.

FIG. 7 is an example of a computerized system supporting the present invention.

### DETAILED DESCRIPTION

The present invention provides a method and system for exchanging property. In particular, the present invention provides a system and method for exchanging property online over a worldwide, computer communications network. The system lists property buyers and renters and provides brokers and sellers with methods to contact the buyers and renters.

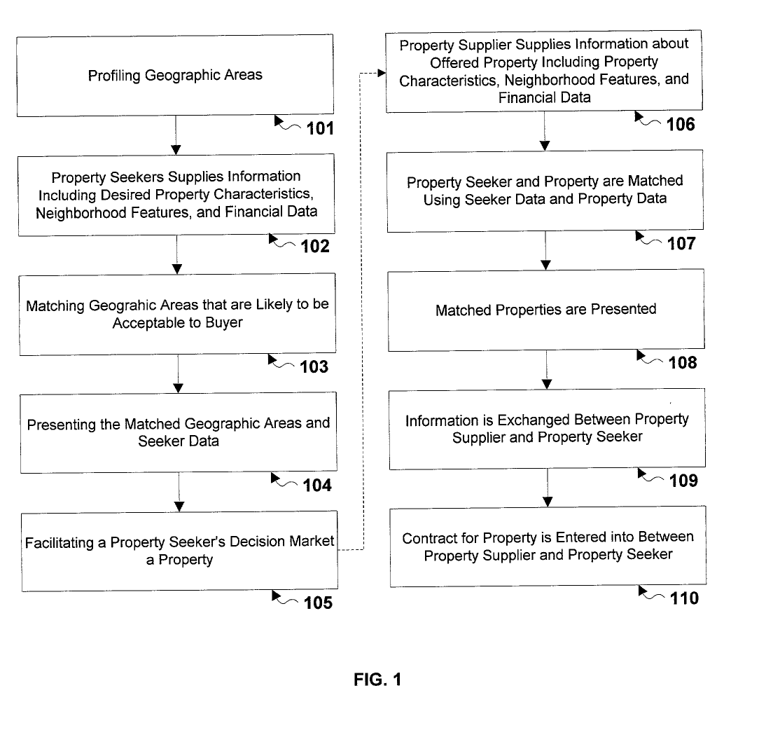

Referring first to FIG. 1, a computerized property exchange method is described. In this embodiment of the invention, property seekers and property suppliers exchange property over a computer communications network, such as the Internet or an Intranet. Geographic areas are first profiled 101. Property seekers then enter information regarding what type of property they are looking for, the desired neighborhood features, and their pertinent financial data 102. Geographic areas are then matched to the property seekers based upon areas that are likely to be acceptable to the buyer 103. The geographic areas and the buyer preferences are then transmitted based on the matches 104. The system can also facilitate a property owner's decision to market a property in a certain neighborhood by providing information about property seeker's interest in the neighborhood and current sales in the neighborhood 105. The system can provide the property seeker with a user-interface control that allows the property supplier to choose to input their property to meet this demand.

Profiles of the geographic areas can include the neighborhood demographics and, location of churches, and schools. Other information, such as park information, including park features, such as zoos, locations for skateboarding, ice skating, and sports can also be included. Similarly, information about local museums, theatres, mass transit, restaurants, shopping, culture, (such as art galleries and fashion), and childcare can also be supplied. Profiles can also include financial information about the geographic area, (e.g., the average price range for property types).

Property suppliers can enter information about the type of properties they are offering 106. Upon user request, characteristics of the seeker's desired property can be matched with the property characteristics of the supplier's property 107. The supplier or the seeker can request this matching service. The matched property can be presented to the requesting party 108. Information can then be exchanged between the supplier and the seeker with respect to the matched property 109. The system can facilitate the entry into a contract for the property between the property seeker and the property supplier 109.

The property seeker can include any entity that is looking to rent or buy a property. The property supplier can include any entity that is looking to rent or sell a property, including property brokers and agents.

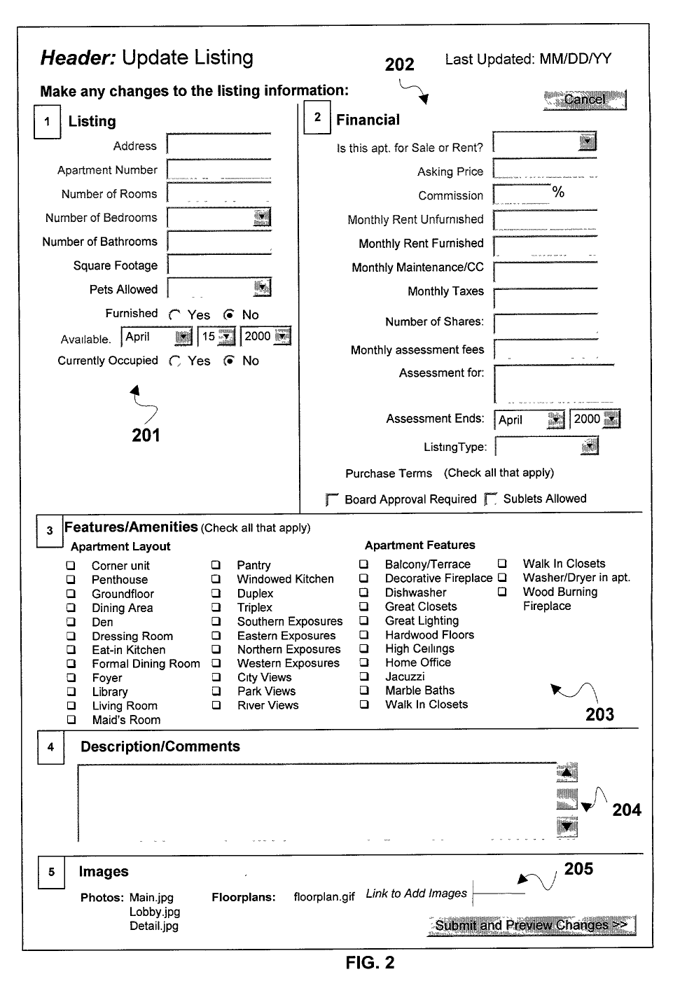

FIG. 2 is a web page that demonstrates one way that the property supplier can input information about its properties. The property supplier can input information about the listing of the property 201. The listing can include the address, number of rooms, number of bedrooms, number of bathrooms, square footage, whether pets are allowed, whether the property is furnished, when the property will be available, and whether the property is currently occupied. The property supplier can also input information regarding the requested financial information of the property 202. The information requested by the system can be changed depending upon whether the apartment is being sold or rented. The financial information can include the asking price or monthly rent and the commission required.

The property supplier can also input information describing the features and amenities of the property 203. This information can include the property layout, which can include whether the property is a corner unit, duplex, triplex, penthouse, or on the ground floor. The property layout can also include whether the property has a dining area, den, dressing room, eat-in kitchen, formal dining room, foyer, library, living room, maid's room, pantry, or windowed kitchen. The property layout can also describe the views and exposures of the property, such as the southern, eastern, northern, or western exposures, or city, park, or river views. Property features can also be included, such as whether the apartment has a balcony or terrace, decorative fireplace, dishwasher, great closets, great lighting, hardwood floors, high ceilings, home office, Jacuzzi, marble baths, walk-in closets, or washer and dryer in apartment.

The property supplier can give further description or comment about the property 204. Finally, the property owner can include pictures of the property, such as photographs of the outside, photographs of the inside, and floor plans 205.

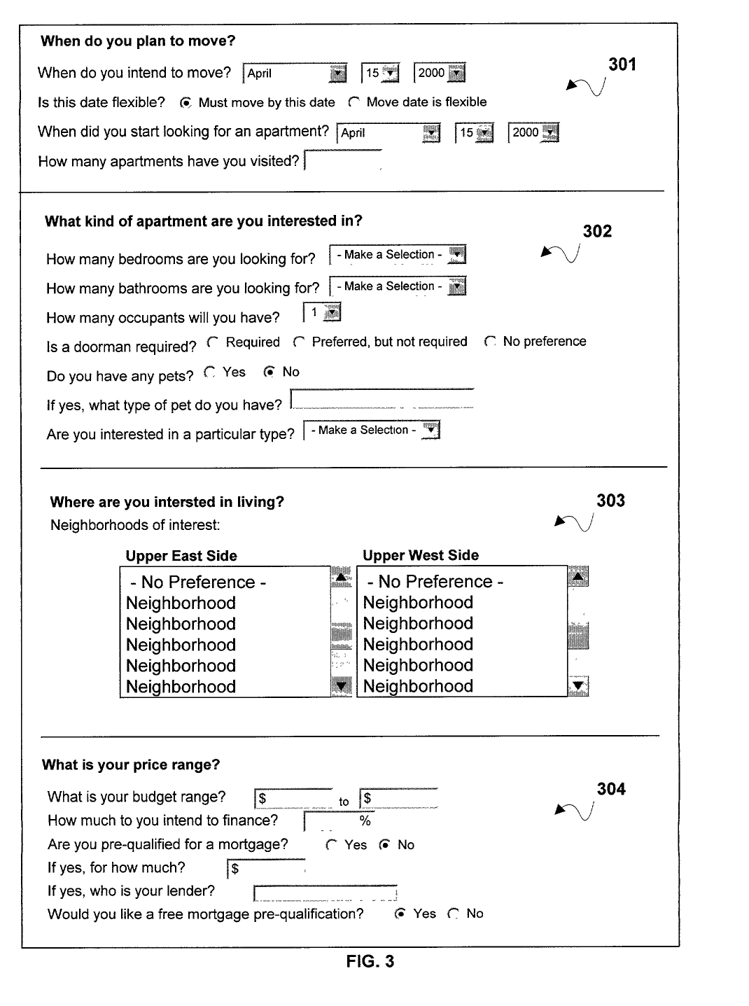

FIG. 3 is a web page that demonstrates how the property seeker can input information about the type of property the seeker is looking for. The seeker can supply information regarding when the seeker plans to move 301. This can include the date of the move, whether the date is flexible, when the seeker started looking for the property, and how many properties the seeker has already visited.

The property seeker can also input the type of apartment the seeker is interested in renting or buying 302. This can include the number of bedrooms, the number of bathrooms, the number of occupants, whether a doorman is required, whether the seeker has any pets, and the type of property the seeker is looking for. The seeker can also input information related to the features and amenities of the property as described in FIG. 2 in Apartment Layout and Apartment Features 203.

The property seeker can select a desired neighborhood they are interested in moving to 303. The selection can be displayed by section of neighborhoods in the area selected. The seeker can also supply a desired price range 304. This price range can include the budget range, whether financing will be sought, and whether the seeker has been pre-qualified for a mortgage (for buyers). The selection of the neighborhood can be facilitated by the system. As described above, the system can suggest neighborhoods based upon the property seeker's input.

The financial information that the property seeker inputs can include the desired transaction type, such as renting or buying. If the property seeker is renting, then information such as the term of years, subsidized rent, Section 8 rent, elder care, and assisted living can be supplied. If the property seeker is looking to buy, then information such as their mortgage qualifications can be supplied.

The property seeker and property supplier can also input personal information that can be exchanged between interested parties upon request. The property seeker can include an interested buyer or renter of property. The property supplier can include an interested seller or representation of a seller, such as a property broker.

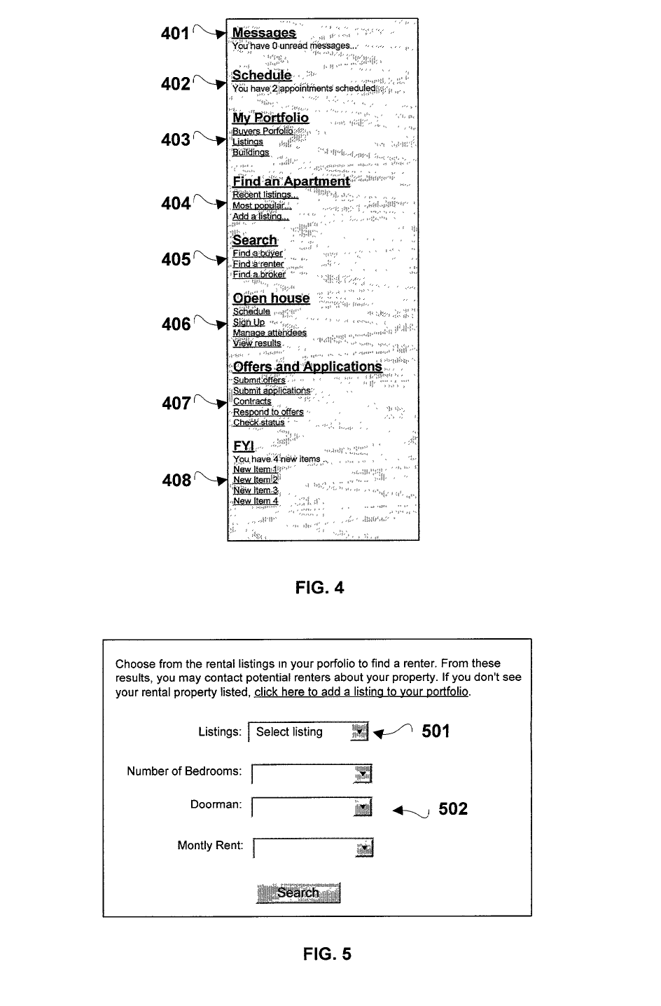

The exchange of information between the property supplier and the property seeker is facilitated by the system. FIG. 4 is a web page that demonstrates the types of information that can be exchanged. Messages, such as e-mails, can be sent between the supplier and the seeker 401. Questions from the seeker, such as “where is the closest grocery store to this property?” can be sent and responded to by the supplier. In these messages, the supplier or the seeker can remain anonymous.

Appointments can be set up between the property supplier and the property seeker 402. These appointments can include a meeting at the property so that the supplier can show the seeker the property. Similarly, the supplier can set up open houses for all prospective seekers 406. Seekers can inform the suppliers if they intend to attend the open house so that the seeker can plan accordingly.

Offers, counteroffers, and applications can also be handled through the system 407. Seekers can submit an offer or application to the supplier. Contracts can be sent back and forth between the supplier and seeker until both parties are satisfied. The status of pending offers or contracts can be checked at any time. This allows the seeker and the supplier to facilitate the exchange of the property over the system.

FIG. 5 is a web page that demonstrates a search that can be conducted by a property supplier for potential renters of the property. The supplier can select the property it wishes to search for seekers for 501. The supplier can also indicate whether to look for a seeker who desires a certain number of bedrooms, a doorman, and a range for the monthly rent 502.

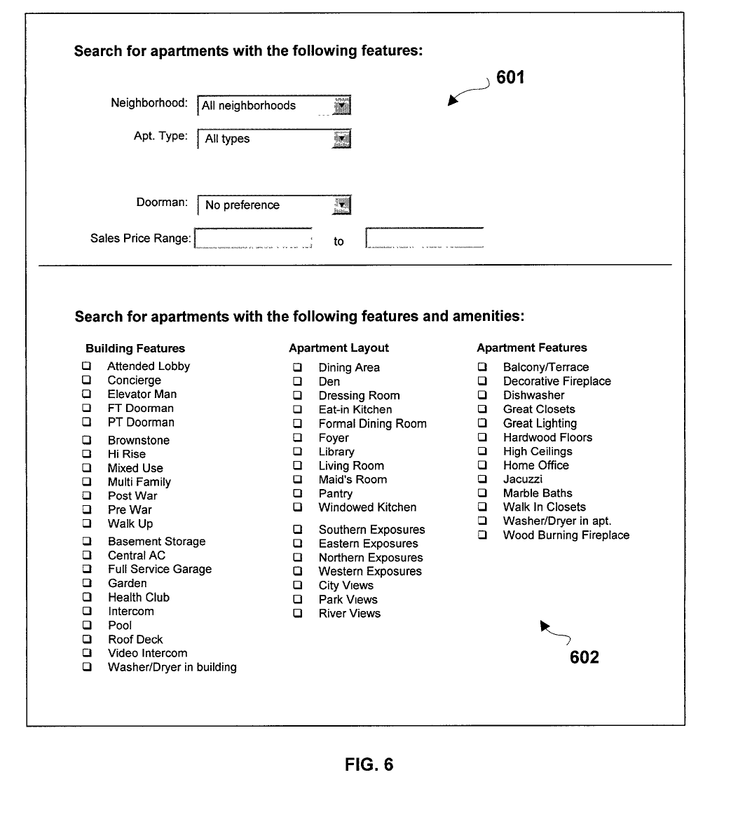

FIG. 6 is a web page that demonstrates a search that can be conducted by a property seeker for a potential property. The seeker inputs the neighborhood to search, the property type, such as apartment, house, duplex, whether there is a doorman, and the sales price range 601. The seeker can also indicate the features and amenities that the property should have 602.

Each property can include reviews and ratings, which can be given by any person familiar with the property. An example of this is a rating given by a current tenant of an apartment building. Similarly, property seekers who have visited a property can fill out a review and rating to inform other property seekers about the property. The ratings and reviews can be compiled to give a general feel of the property to a property seeker.

Statistics about the properties can also be stored in the system. These statistics can include properties that have been sold or rented in a given neighborhood. This can enable a property supplier to develop a price for the properties it has offered. This can also enable property seekers to determine the neighborhood that they are interested in by viewing what has currently been sold or rented and the prices for those properties. The system can store statistics, such as the property's financial information, neighborhood, and property characteristics. Both the supplier and seeker can use this information in determining the current marketplace for properties.

The system can also store and display information about the most popular neighborhoods, brokers, and properties. The information can be ranked according to surveys, statistics, and most visited locations on the site.

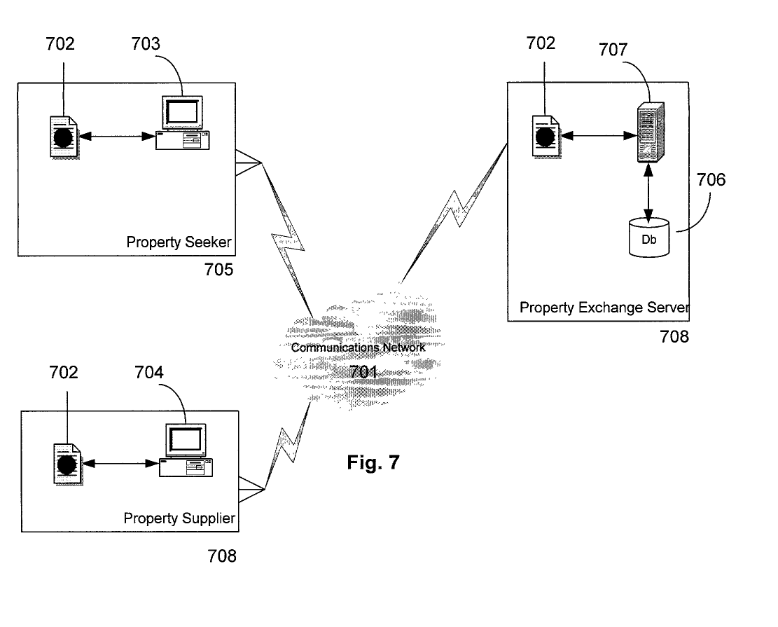

Referring to FIG. 7, the property seeker and the property supplier can input and receive information through a computer connected to a computer communications network 701. The property seeker 705 connects to the property exchange server 708 through a computer 703 connected to the computer communications network 701. The property seeker 705 can then conduct transactions 702 through the server 708 as discussed above. Similarly, the property supplier 708 connects to the property exchange server 708 through a computer 704 connected to the computer communications network 701. The property supplier 708 can then conduct transactions 702 through the server 708 as discussed above.

The property exchange server 708 connects to all client computers through a computer communications network 701. The property exchange server 708 can include a computer server 707 that accesses a database 706, which stores information about the property seekers, property suppliers, and properties.

The transactions 702 can take place across web pages or other network communication devices. For example, a web site can be set up to facilitate the communications and transactions between the property seekers and the property suppliers.

A number of embodiments of the present invention have been described. Nevertheless, it will be understood that various modifications may be made without departing from the spirit and scope of the invention. For example, computers 703, 704, and 707 can comprise a personal computer executing an operating system such as Microsoft Windows™, Unix™, or Apple Mac OS™, as well as software applications, such as a web browser. Computers 703, 704, and 707 can also be terminal devices, a palm-type computer WEB access device that adhere to a point-to-point or network communication protocol such as the Internet protocol. Other examples can include TV WEB browsers, terminals, and wireless access devices (such as a 3-Com Palm organizer). A client computer may include a processor, RAM and/or ROM memory, a display capability, an input device and hard disk or other relatively permanent storage. Accordingly, other embodiments are within the scope of the following claims.

What is claimed is:

1. A computer implemented method of facilitating real estate transactions, the method comprising:
receiving data descriptive of real estate characteristics of a neighborhood;
creating a profile of the neighborhood comprising the received data descriptive of the real estate characteristics of the neighborhood;
receiving data descriptive of a property sought by a property seeker comprising property characteristics desired by the property seeker and neighborhood features desired by the property seeker;
receiving data descriptive of the financial commitment that the property seeker is prepared to make;
receiving a query from a property supplier relating to demand for a subject property with particular characteristics and neighborhood;
matching the data descriptive of a property sought by a property seeker with the characteristics of the query property and a profile of the query neighborhood; and
transmitting to the property supplier data indicative of the demand for a property with the characteristics and neighborhood received in the query.

2. The method of claim 1, additionally comprising the steps of:
matching the property seeker with the subject property according to the received data relating to a property sought and property data;
presenting the matched property and property seeker via a graphical user interface; and
facilitating the exchange of information between the property supplier and the property seeker.

3. The method of claim 2, wherein the step of matching the property seeker with the subject property additionally comprises using a plurality of matched geographic areas to assist in matching the property characteristics of the property with the property characteristics of the property seeker.

4. The method of claim 2, additionally comprising facilitating the exchange of the property between the property supplier and the property seeker.

5. The method of claim 2, additionally comprising:
profiling the property, wherein an individual supplies information regarding the property comprising a review and a rating; and
presenting the profiled plurality of properties to an interested property seeker.

6. The method of claim 5, wherein the individual comprises a person selected from the list comprising a current tenant of the property and a property seeker who has visited the property.

7. The method of claim 2, wherein the property characteristics additionally comprises available moving-in times.

8. The method of claim 2, wherein the property characteristics additionally comprises:
number of bedrooms;
number of bathrooms;
housing type; and neighborhood.

9. The method of claim 2, wherein the property characteristics additionally comprises:
number of occupants;
doorman availability;
pets allowed; and apartment furnishings.

10. The method of claim 2, wherein the property characteristics additionally comprises:
a choice of desired amenities chosen from the list comprising:
corner unit; penthouse; ground floor; balcony; central air-conditioning; dining room; den; eat-in kitchen; dressing room; elevator; garage; good light; hardwood floors; health club; high ceilings; home office; library; foyer; maid's room; pantry; windowed kitchen; duplex; triplex; living room; fireplace; Jacuzzi; post-war building; pre-war building; views; exposures; walk-up; washer and dryer in apartment; and washer and dryer in building.

11. The method of claim 1, wherein the neighborhood features comprises
a choice of desired features chosen from the list comprising:
neighborhood demographics, churches, schools, parks, zoos, sport arenas, sport facilities, gyms, museums, theatres, mass transit, restaurants, shopping, art galleries, fashion galleries, and childcare facilities.

12. The method of claim 1, wherein the property seeker comprises an entity buying property.

13. The method of claim 1, wherein the property seeker comprises an entity renting property.

14. The method of claim 2, wherein the property supplier comprises an entity selling property.

15. The method of claim 2, wherein the property supplier comprises an entity offering property for rent.

16. The method of claim 2, wherein the property supplier comprises an entity brokering property.

17. The method of claim 4, additionally comprising:
compiling statistics for a plurality of exchanged properties.

18. The method of claim 17, wherein the statistics additionally comprises:
information about an exchanged property's financial information;
information about an exchanged property's neighborhood; and
information about an exchanged property's property type.

19. The method of claim 2, wherein the step of facilitating the exchange of information between the property supplier and the property seeker additionally comprises scheduling appointments between the property supplier and the property seeker.

20. The method of claim 2, wherein the step of facilitating the exchange of information between the property supplier and the property seeker additionally comprises exchanging messages between the property supplier and the property seeker.

21. The method of claim 20, wherein the messages comprise anonymous messages.

22. The method of claim 2, wherein the step of facilitating the exchange of information between the property supplier and the property seeker additionally comprises offers and counteroffers by the property seeker and the property supplier for the property.

23. The method of claim 2, wherein the step of profiling a plurality of properties additionally comprises supplying pictures of the property with the property profile.

24. The method of claim 1, wherein the financial data additionally comprises transaction type the property seeker plans to use.

25. A computer system for providing property exchange, the system comprising:
a computer server accessible via a computer communications network, wherein the server comprises a memory and a processor;
executable software residing in the server memory wherein the software is operative with the processor to:
profile a plurality of geographic areas;
profile a property seeker, wherein the property seeker supplies seeker data comprising:
property characteristics desired by the property seeker;
neighborhood features desired by the property seeker; and
financial data describing the property seeker;
match the plurality of geographic areas with the seeker data;
present the matched geographic areas and seeker data; and
facilitate a property seeker's decision to market a property.

26. The computer system of claim 25, wherein the software is executable on demand via a network access device.

27. The computer system of claim 26, wherein the network access device comprises a computer.

28. The computer system of claim 25, wherein the computer communication network conforms to a transmission control protocol/Internet protocol.

29. The computer system of claim 25, wherein the computer communication network additionally comprises an intranet.

30. The computer system of claim 25, additionally comprising a web interface for accessing the executable software stored on the server storage medium.

31. A computer data signal for providing property exchange embodied in a digital data stream, wherein the computer data signal is generated by a method comprising the steps of:
profiling a plurality of geographic areas;
profiling a property seeker, wherein the property seeker supplies seeker data comprising:
property characteristics desired by the property seeker;
neighborhood features desired by the property seeker; and
financial data describing the property seeker;
matching the plurality of geographic areas with the seeker data;
presenting the matched geographic areas and seeker data; and
facilitating a property seeker's decision to market a property.

32. A computer data signal as in claim 31, wherein the signal generated adheres to the transmission control protocol/Internet protocol.

33. A graphical user interface comprising:
a web page displayable on an internet compatible browser, the web page comprising links to:
profile a plurality of geographic areas;
profile a property seeker, wherein the property seeker supplies seeker data comprising:
property characteristics desired by the property seeker;
neighborhood features desired by the property seeker; and
financial data describing the property seeker;
match the plurality of geographic areas with the seeker data;
present the matched geographic areas and seeker data; and
facilitate a property seeker's decision to market a property.

34. The interface of claim 33, wherein the web page additionally comprises links to:
electronic messages between a property seeker and a property suppliers;
current portfolios; and
search listings, wherein the listings comprise:
buyer information;
renter information;
broker information; and
most popular listings.

35. The interface of claim 34, wherein the messages additionally comprise:
scheduled meetings between the property seekers and the property suppliers;
offers, counteroffers, and applications from the property seekers to the property suppliers; and
open house information.

36. The interface of claim 34, wherein the most popular listings comprise:
most popular neighborhoods;
most popular brokers; and
most popular properties.
